(19) United States
(12) Patent Application Publication
(10) Pub. No.: US 2026/0086409 A1
(43) Pub. Date: Mar. 26, 2026

(54) ELECTRONIC DEVICE

(71) Applicants: Innolux Corporation, Miaoli County (TW); CARUX TECHNOLOGY PTE. LTD., SINGAPORE (SG)

(72) Inventors: Yi-Chuan Kuo, Tainan (TW); Shun-Chen Yang, Tainan (TW); Chi-Wei Chen, Miaoli County (TW); Tzu-Yi Lin, Miaoli County (TW)

(73) Assignees: Innolux Corporation, Miaoli County (TW); CARUX TECHNOLOGY PTE. LTD., SINGAPORE (SG)

(21) Appl. No.: 19/291,613

(22) Filed: Aug. 6, 2025

(30) Foreign Application Priority Data
Sep. 26, 2024 (CN) 202411353413.8

(51) Int. Cl. G02F 1/13363; G02F 1/1335; G02F 1/13357

(52) U.S. Cl. CPC G02F 1/13363; G02F 1/133528; G02F 1/1336

(57) ABSTRACT

An electronic device is provided. The electronic device includes a panel and a super retardation film. The super retardation film is disposed on the panel. When the panel displays a white screen, a spectrum measured on a light emitting surface of the panel has a first main wave. A first peak of the first main wave is greater than or equal to 580 nm and less than or equal to 680 nm, the first main wave has a first full width at half maximum range, and the first full width at half maximum range is greater than or equal to 15 nm.

### CROSS-REFERENCE TO RELATED APPLICATION

This application claims the priority benefit of China application serial no. 202411353413.8, filed on September 26, 2024. The entirety of the above-mentioned patent application is hereby incorporated by reference herein and made a part of this specification.

### BACKGROUND

### Technical Field

The disclosure relates to an electronic device.

### Description of Related Art

With the development of technology, more and more electronic devices are equipped with displays to provide display functions. However, a display image provided by the display may be affected by an object (for example, (linearly polarized) sunglasses) worn by the user, which may affect the brightness quality of viewing.

Alternatively, when the display is rotated or the tilt angle of the display is changed, the brightness viewed by the user may be reduced, which may cause driving safety issues in the field of automotive displays, and may also cause unexpected interference or diffraction (for example, a rainbow pattern or a Moiré pattern), affecting the viewing experience of the user. How to solve the above issues still requirements to be solved by relevant manufacturers.

### SUMMARY

The disclosure provides an electronic device and an electronic device configured to be installed on a transportation device, which can increase shielding of a display beam by linearly polarized sunglasses.

According to an embodiment of the disclosure, an electronic device includes a panel and a super retardation film. The super retardation film is disposed on the panel. When the panel displays a white screen, a spectrum measured on a light emitting surface of the panel has a first main wave. A first peak of the first main wave is greater than or equal to 580 nm and less than or equal to 680 nm, and the first main wave has a first full width at half maximum range, and the first full width at half maximum range is greater than or equal to 15 nm.

According to an embodiment of the disclosure, an electronic device is configured to be installed on a transportation device. The electronic device includes a panel, a super retardation film, and a control module. The super retardation film is disposed on the panel. The control module is configured to rotate the panel or adjust a tilt angle of the panel.

In order for the features and advantages of the disclosure to be more comprehensible, the following specific embodiments are described in detail in conjunction with the drawings.

### BRIEF DESCRIPTION OF THE DRAWINGS

FIG. 1 is a schematic structural diagram of an electronic device according to some embodiments of the disclosure.

FIG. 2 is a schematic structural diagram of an electronic device according to some embodiments of the disclosure.

FIG. 3 is a schematic structural diagram of an electronic device according to some embodiments of the disclosure.

FIG. 4 is a schematic structural diagram of an electronic device according to some embodiments of the disclosure.

FIGS. 5A to 5E are respectively five spectrum diagrams of a panel in an electronic device when displaying a white screen according to some embodiments of the disclosure.

FIG. 6 is a schematic spectrum comparison diagram of a backlight module of an electronic device according to an embodiment of the disclosure.

FIG. 7 is a schematic structural diagram of an electronic device according to some embodiments of the disclosure.

### DESCRIPTION OF THE EMBODIMENTS

Reference will now be made in detail to the exemplary embodiments of the disclosure, and examples of the exemplary embodiments are illustrated in the drawings. Wherever possible, the same reference numerals are used in the drawings and the description to represent the same or similar parts.

Throughout the specification and the appended claims of the disclosure, certain words are used to refer to specific elements. Persons skilled in the art should understand that electronic device manufacturers may refer to the same elements by different names. The disclosure does not intend to distinguish the elements with the same function but different names. In the following specification and claims, words such as "containing" and "comprising" are open-ended words, which should be interpreted as "including but not limited to...".

Directional terms such as “upper”, “lower”, “front”, “rear”, “left”, and “right” mentioned in the disclosure are only directions with reference to the drawings. Therefore, the used directional terms are used to illustrate, but not to limit, the disclosure. In the drawings, each drawing illustrates the general characteristics of a method, a structure, and/or a material used in a specific embodiment. However, the drawings should not be construed to define or limit the scope or the nature covered by the embodiments. For example, the relative sizes, thicknesses, and positions of various film layers, regions, and/or structures may be reduced or enlarged for clarity.

When a structure (or layer, element, base) is described in the disclosure as being located on/above another structure (or layer, element, base), it may mean that the two structures are adjacent and directly connected or it may mean that the two structures are adjacent but not directly connected. Indirect connection means that there is at least one intermediate structure (or intermediate layer, intermediate element, intermediate base, intermediate spacing) between the two structures. A lower surface of one structure is adjacent or directly connected to an upper surface of the intermediate structure, and an upper surface of the other structure is adjacent or directly connected to a lower surface of the intermediate structure. The intermediate structure may be composed of a single-layer or multi-layer physical structure or non-physical structure, which is not limited. In the disclosure, when a certain structure is disposed “on” another structure, it may mean that the certain structure is “directly” on the other structure or it may mean that the certain structure is “indirectly” on the other structure, that is, at least one structure is also sandwiched between the certain structure and the other structure.

The terms “about”, “substantially”, or “roughly” are generally interpreted as within 10% of a given value or range, or interpreted as within 5%, 3%, 2%, 1%, or 0.5% of the given value or range. In addition, the terms "a range is from a first value to a second value" and "a range is between a first value and a second value" mean that the range includes the first value, the second value, and other values therebetween.

Ordinal numbers such as “first” and “second” used in the specification and the claims are used to modify elements, and the terms do not imply and represent that the element(s) have any previous ordinal number, nor do they represent the order of a certain element and another element or the order of a manufacturing method. The use of the ordinal numbers is only used to clearly distinguish between an element with a certain name and another element with the same name. The claims and the specification may not use the same terms, whereby a first member in the specification may be a second member in the claims.

Electrical connection or coupling described in the disclosure may refer to direct connection or indirect connection. In the case of direct connection, terminals of elements on two circuits are directly connected or connected to each other by a conductor segment. In the case of indirect connection, there is a switch, a diode, a capacitor, an inductor, a resistor, other suitable elements, or a combination of the above elements between the terminals of the elements on the two circuits, but not limited thereto.

In the disclosure, the measurement manner of thickness, length, and width may be by adopting an optical microscope, and the thickness or the width may be obtained by measuring a cross-sectional image in an electron microscope, but not limited thereto. In addition, there may be a certain error between any two values or directions for comparison. In addition, the term "a given range is from a first value to a second value", "a given range falls within a range of a first value to a second value", or "a given range is between a first value and a second value" means that the given range includes the first value, the second value, and other values therebetween. If a first direction is perpendicular to a second direction, an angle between the first direction and the second direction may be between 80 degrees and 100 degrees; and if the first direction is parallel to the second direction, the angle between the first direction and the second direction may be between 0 degrees and 10 degrees.

Unless otherwise defined, all terms (including technical and scientific terms) used herein have the same meaning as commonly understood by persons skilled in the art to which the disclosure belongs. It can be understood that the terms, such as the terms defined in commonly used dictionaries, should be interpreted as having meanings consistent with the relevant art and the background or the context of the disclosure, and should not be interpreted in an idealized or overly formal manner, unless otherwise defined in the embodiments of the disclosure.

In the disclosure, an electronic device may include a display device, a backlight device, an antenna device, a packaging device, a sensing device, or a splicing device, but not limited thereto. The electronic device may be a bendable or flexible electronic device. The display device may be a non-self-luminous display device or a self-luminous display device. The display device may, for example, include liquid crystal, a light emitting diode, fluorescence, phosphor, quantum dot (QD), other suitable display media, or a combination of the above. The antenna device may, for example, include a reconfigurable intelligent surface (RIS), a frequency selective surface (FSS), a radio frequency filter (RF filter), a polarizer, a resonator, an antenna, etc. The antenna may be a liquid crystal antenna or a varactor diode antenna. The sensing device may be a sensing device for sensing capacitance, light, heat energy, or ultrasonic waves, but not limited thereto. In the disclosure, the electronic device may include an electronic element. The electronic element may include a passive element and an active element, such as a capacitor, a resistor, an inductor, a diode, and a transistor. The diode may include a light emitting diode, a varactor diode, or a photodiode. The light emitting diode may, for example, include an organic light emitting diode (OLED), a mini LED, a micro LED, or a QD LED, but not limited thereto. The splicing device may, for example, be a display splicing device or an antenna splicing device, but not limited thereto. It should be noted that the electronic device may be any permutation and combination of the above, but not limited thereto. The packaging device may be a packaging device suitable for wafer-level package (WLP) technology or panel-level package (PLP) technology, such as a chip first process or an RDL first process. In addition, the appearance of the electronic device may be a rectangle, a circle, a polygon, a shape with curved edges, or other suitable shapes. The electronic device may have a peripheral system such as a driving system, a control system, and a light source system to support a display device, an antenna device, a wearable device (such as including augmented reality or virtual reality), a vehicle-mounted device (such as including a car windshield), or a splicing device.

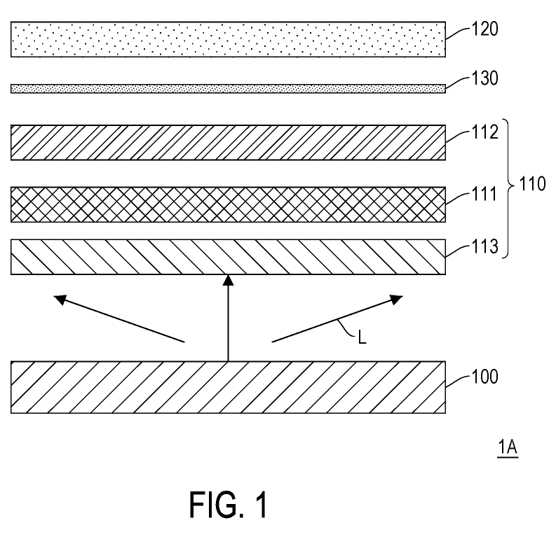

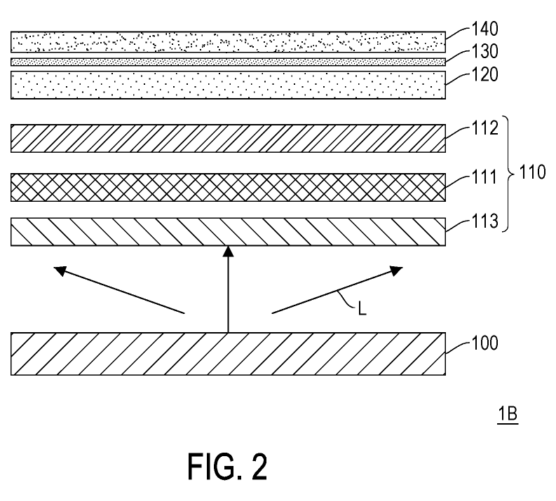

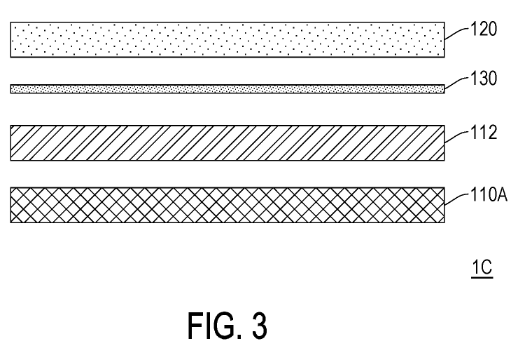

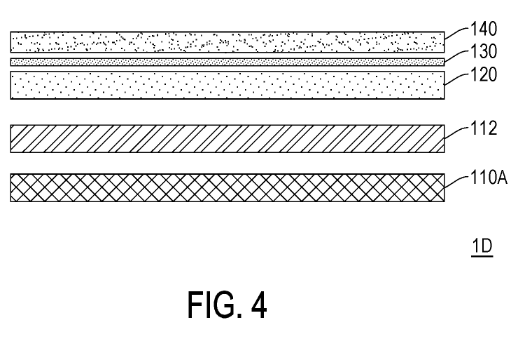

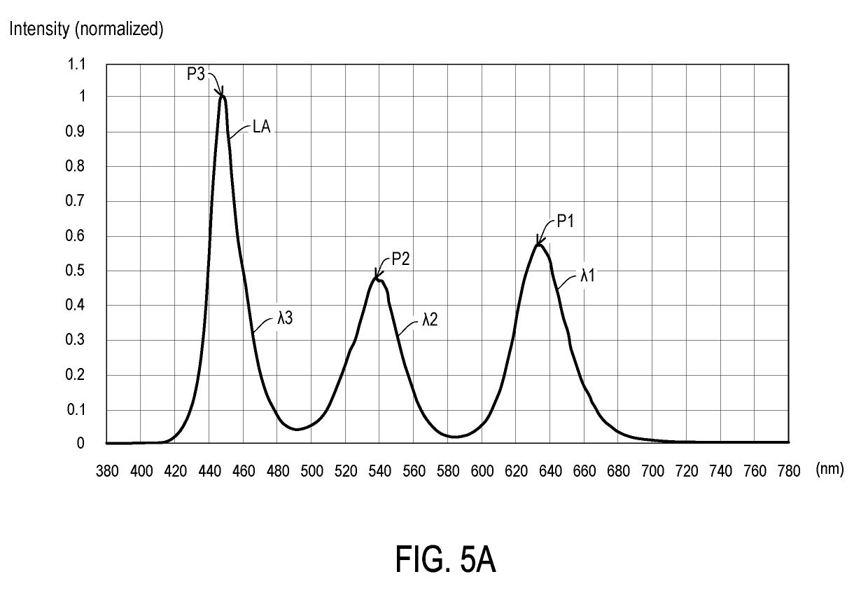

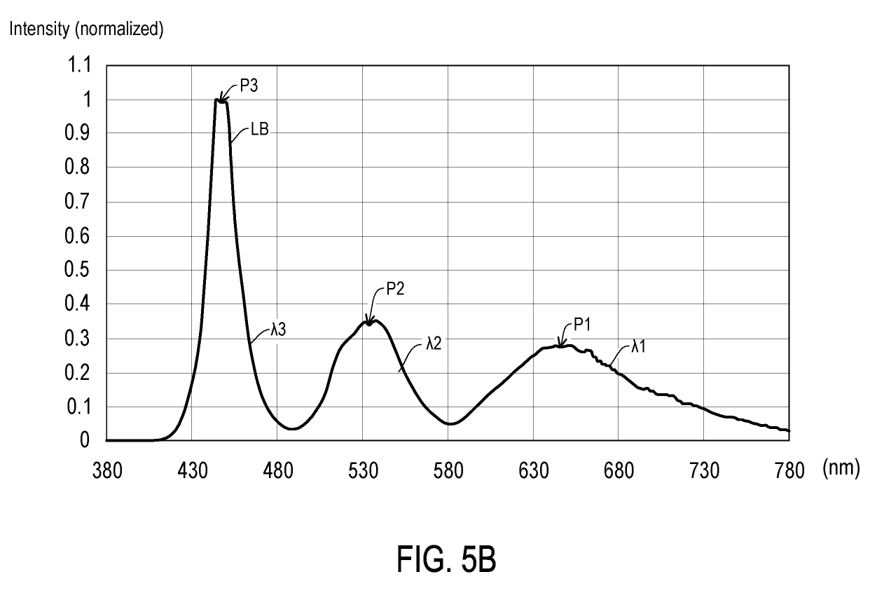

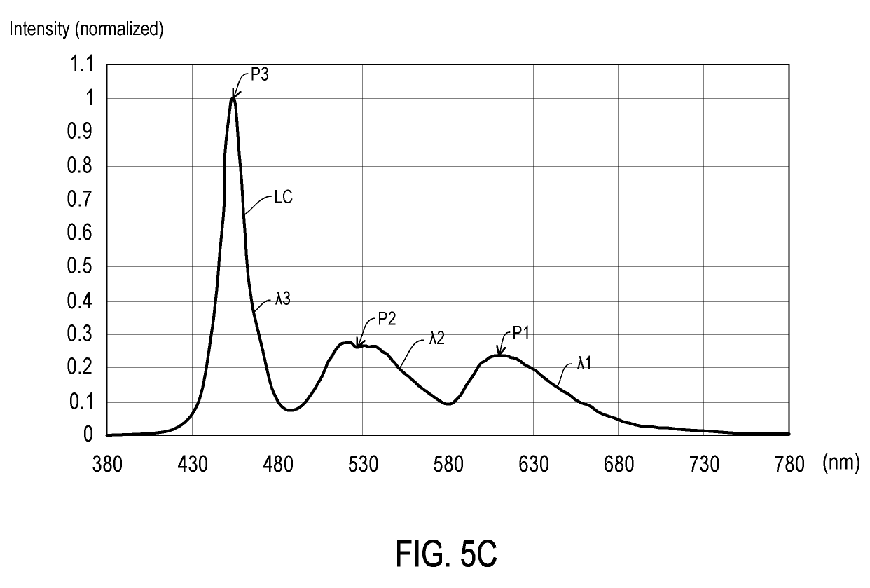

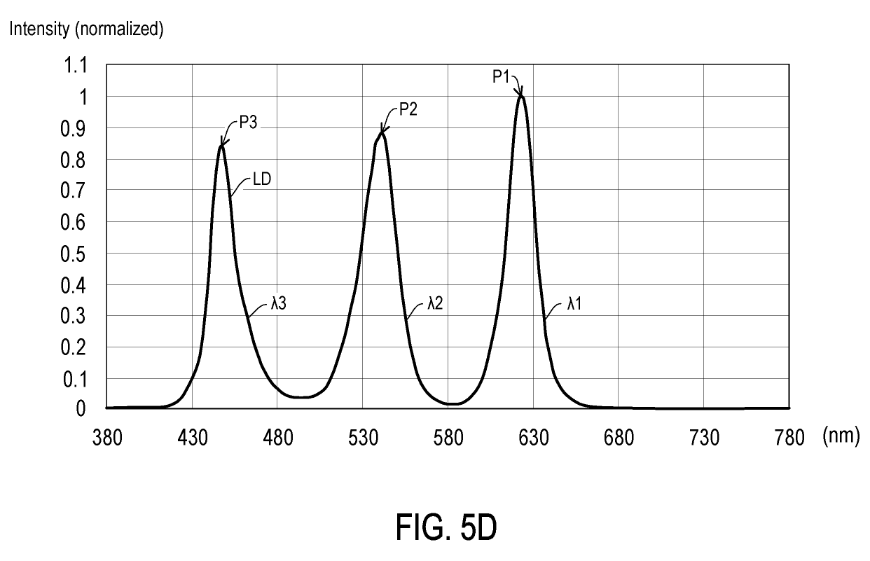

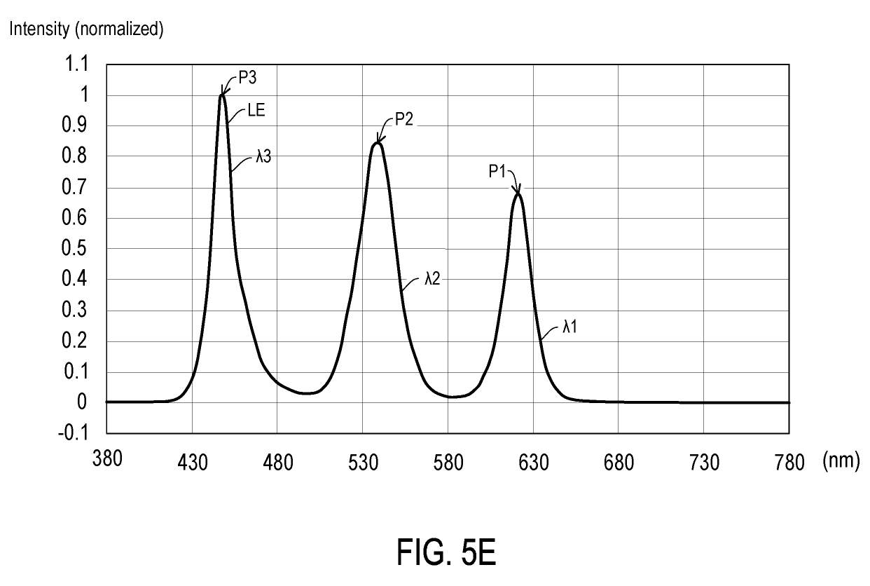

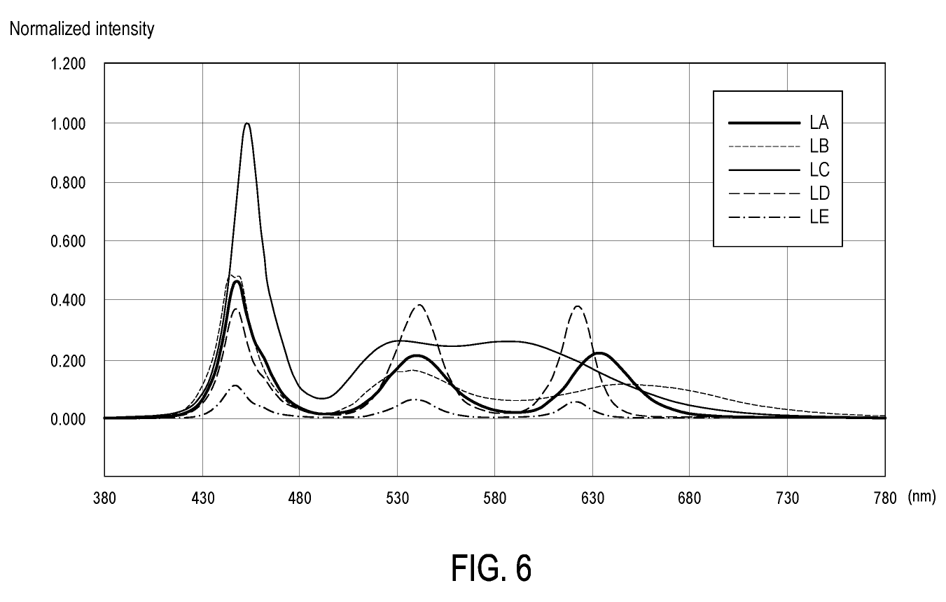

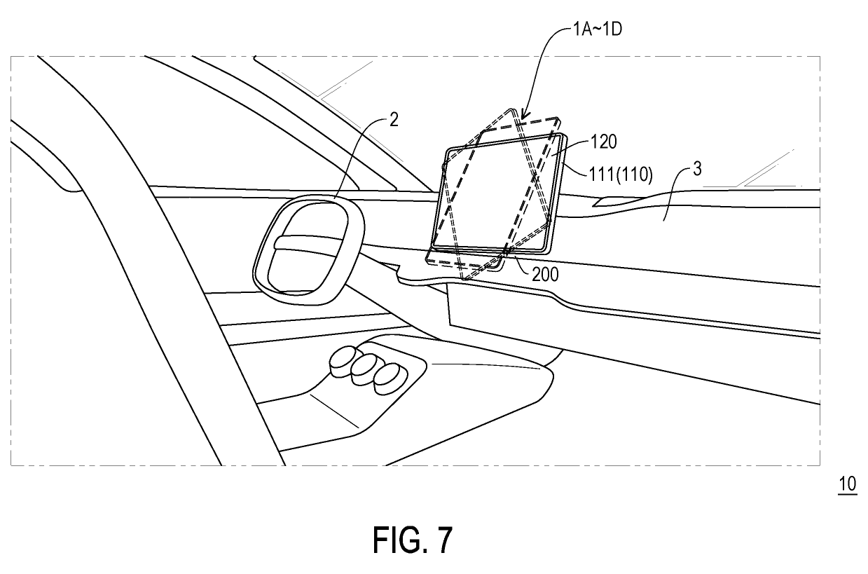

FIG. 1 is a schematic structural diagram of an electronic device according to some embodiments of the disclosure; FIG. 2 is a schematic structural diagram of an electronic device according to some embodiments of the disclosure; FIG. 3 is a schematic structural diagram of an electronic device according to some embodiments of the disclosure; FIG. 4 is a schematic structural diagram of an electronic device according to some embodiments of the disclosure; FIG. 5A to FIG. 5E are respectively five spectrum diagrams of a panel in an electronic device when displaying a white screen according to some embodiments of the disclosure; FIG. 6 is a schematic spectrum comparison diagram of a backlight module of an electronic device according to an embodiment of the disclosure; and FIG. 7 is a schematic structural diagram of an electronic device according to some embodiments of the disclosure. The electronic device is configured to be installed on a transportation device. It should be noted that the following embodiments may be replaced, reorganized, and mixed with features of several different embodiments to complete other embodiments without departing from the spirit of the disclosure. The features of various embodiments may be mixed and matched as long as the features do not violate the spirit of the invention or conflict with each other.

In the embodiment of the disclosure, the transportation device is, for example, a vehicle, a ship, an airplane. or other transportation devices. The type of the vehicle is not limited.

Please refer to FIG. 1. An electronic device 1A may include a backlight module 100, a display module 110, a super retardation film 120, and an adhesion layer 130, but not limited thereto. The electronic device 1A may add or remove one or more of the above elements according to requirements.

In some embodiments, the backlight module 100 may include a light emitting unit (not shown) and a light conversion element (not shown) disposed on the light emitting unit. The light emitting unit is, for example, a micro light emitting diode (micro LED), a mini LED, or light emitting diodes with other sizes. According to different types of structures, the light emitting unit may be a flip-chip type light emitting diode, a vertical type light emitting diode, or a lateral type light emitting diode. For example, the light emitting units may be respectively configured to emit beams in a blue light wave band. The light conversion element includes, for example, a fluorescence material, a phosphor material, quantum dot (QD), or other suitable materials and is configured to convert the beam emitted by the light emitting unit into a beam L. The light conversion element may be, for example, a light conversion material for converting the blue light wave band (or other color lights with short wavelengths) into a color light with a higher wavelength (for example, a yellow light wave band). For example, the light conversion element may be a conversion layer including red phosphor and green phosphor, a conversion layer including yellow phosphor and red phosphor, or yellow phosphor, such as including yttrium aluminum garnet (YAG). Therefore, the spectrum of the beam L emitted by the backlight module 100 may include a main wave located in a red light wavelength range (for example, the wavelength is greater than or equal to 580 nm and less than or equal to 680 nm), a main wave located in a green light wavelength range (for example, the wavelength is greater than or equal to 480 nm and less than or equal to 579 nm), and a main wave located in a blue light wavelength range (for example, the wavelength is greater than or equal to 380 nm and less than or equal to 479 nm). In other words, the beam L emitted by the backlight module 100 may be regarded as a white light spectrum, but not limited thereto.

The display module 110 is disposed on the backlight module 100 and is configured to receive the beam L from the backlight module 100. In the embodiment, the display module 110 includes, for example, a panel 111, an upper polarizing plate 112, and a lower polarizing plate 113. The panel 111 may include a pixel array substrate (not shown), an opposite substrate (not shown), and a display layer, such as a liquid crystal layer (not shown), sandwiched between the pixel array substrate and the opposite substrate. An electric field between the pixel array substrate and the opposite substrate may be changed through changing a voltage applied to a pixel electrode of the pixel array substrate, so as to drive multiple liquid crystal molecules in the display layer (a liquid crystal layer) to rotate. The magnitude of the electric field may determine an axial distribution of the liquid crystal molecules, thereby generating a corresponding phase retardation in an incident polarized light and changing a polarization state thereof, so that an outgoing light has a corresponding brightness. Therefore, pixel electrodes with different potentials may enable the outgoing lights to have different light intensities (or gray scales), so as to achieve image display effects. The upper polarizing plate 112 and the lower polarizing plate 113 may have penetration axes that are perpendicular to each other or parallel to each other, but the disclosure is not limited thereto. Taking the upper polarizing plate 112 and the lower polarizing plate 113 having penetration axes that are perpendicular to each other as an example, the beam L from the backlight module 100 is, for example, an unpolarized light. The unpolarized light is converted into a beam in a first linear polarization state (a beam whose polarization direction is parallel to the penetration axis of the lower polarizing plate 113) after passing through the lower polarizing plate 113. The beam in the first linear polarization state may be controlled by the panel 111 to be converted into a display beam in a second linear polarization state (a beam whose polarization direction may be roughly parallel to the penetration axis of the upper polarizing plate 112, but not limited thereto), so that the display beam in the second linear polarization state may pass through the upper polarizing plate 112.

In the embodiment of the disclosure, the type of the liquid crystal molecules in the liquid crystal layer is not limited. For example, the liquid crystal molecules may be twisted nematic (TN) liquid crystal molecules, vertical alignment (VA) liquid crystal molecules, in-plane switching (IPS) liquid crystal molecules, or fringe field switching (FFS) liquid crystal molecules, but not limited thereto. Correspondingly, the panel 111 may be any type of liquid crystal panel, such as a twisted nematic liquid crystal display panel, a vertical alignment liquid crystal panel, an in-plane switching liquid crystal panel, or a fringe field switching liquid crystal panel, but the disclosure is not limited thereto.

The super retardation film (SRF) 120 is disposed on the panel 111. Furthermore, the upper polarizing plate 112 may be disposed between the super retardation film 120 and the panel 111. It should be noted that the super retardation film 120 may be a phase retardation thin film with a high in-plane phase difference value (Ro). The in-plane phase difference value Ro=(nx-ny)*D, where d is the thickness of the super retardation film 120, nx is the refractive index of the super retardation film 120 in a slow-axis direction, ny is the refractive index of the super retardation film 120 in a fast-axis direction, and the fast-axis direction is perpendicular to the slow-axis direction. The preparation of the super retardation film 120 is similar to that of a polyester thin film (for example, a polyethylene terephthalate (PET) thin film), which may exhibit anisotropic optical performance through adjusting an extension ratio during an extension process, so that a linearly polarized light passing through the super retardation film 120 is converted into an elliptically polarized light, but not limited thereto. In some embodiments, the in-plane phase difference value Ro of the super retardation film 120 may be greater than or equal to 3000 nm and less than or equal to 30000 nm, but not limited thereto. In some embodiments, the in-plane phase difference value Ro of the super retardation film 120 may be greater than or equal to 3500 nm and less than or equal to 25000 nm, but not limited thereto. In some embodiments, the in-plane phase difference value Ro of the super retardation film 120 may be greater than or equal to 4000 nm and less than or equal to 15000 nm, but not limited thereto. In some embodiments, the in-plane phase difference value Ro of the super retardation film 120 may be greater than or equal to 4500 nm and less than or equal to 10000 nm, but not limited thereto. In some embodiments, the in-plane phase difference value Ro of the super retardation film 120 may be greater than or equal to 4500 nm and less than or equal to 9000 nm, but not limited thereto.

Phase retardation is performed on the display beam leaving the upper polarizing plate 112 by the super retardation film 120, so that the linear polarization state (for example, the second linear polarization state) of the display beam changes. In detail, since the wave band distribution of the beam L includes the red light wavelength range, the green light wavelength range, and the blue light wavelength range, the wave band distribution of the display beam emitted by the panel 111 is also similar to the wave band distribution of the beam L. There is an included angle between the slow axis of the super retardation film 120 and an absorption axis of the upper polarizing plate 112. Therefore, after the phase difference is generated in the display beam by the super retardation film 120, the linearly polarized lights of different wave bands in the display beam may be converted into elliptically polarized lights of different degrees. Since the elliptically polarized light is not completely absorbed/shielded by linearly polarized sunglasses at any angle, the user may still view a display screen provided by the electronic device 1A when the electronic device 1A is rotated to any angle. In addition, compared with using a quarter-wave plate to form circularly polarized light, the super retardation film 120 generates smaller color shifts at each viewing angle, has a lower cost, is easy to assembly, and has high technical flexibility. On the other hand, by providing a high phase retardation amount through the super retardation film 120, the rainbow pattern caused by interference of different light wavelengths is alleviated and may even be indiscernible to the human eyes. In some embodiments, the included angle between the slow axis of the super retardation film 120 and the absorption axis of the upper polarizing plate 112 may be greater than or equal to 30 degrees and less than or equal to 60 degrees, but not limited thereto. In some embodiments, the included angle between the slow axis of the super retardation film 120 and the absorption axis of the upper polarizing plate 112 may be greater than or equal to 35 degrees and less than or equal to 55 degrees, but not limited thereto. In some embodiments, the included angle between the slow axis of the super retardation film 120 and the absorption axis of the upper polarizing plate 112 may be greater than or equal to 40 degrees and less than or equal to 50 degrees, but not limited thereto. In this way, the super retardation film 120 may significantly alleviate the rainbow pattern.

In some embodiments, the rainbow pattern may be further alleviated through adjusting a spectrum when the panel 111 displays a white screen. Specifically, when the panel 111 of the electronic device 1A displays the white screen, the spectrum measured on a light emitting surface of the panel 111 has a first main wave λ1, and a first peak P1 of the first main wave λ1 is greater than or equal to 580 nm and less than or is equal to 680 nm, and the first main wave has a first full width at half maximum range of greater than or equal to 15 nm.

The spectrum of the white screen of the panel according to different embodiments of the disclosure will be described below. Please refer to FIG. 5A to FIG. 5E. In the embodiment of FIG. 5A, a spectrum LA is generated under a structure in which the light emitting unit includes, for example, a blue LED and the light conversion element includes, for example, a first type quantum dot. In the embodiment of FIG. 5B, a spectrum LB is generated under a structure in which the light emitting unit includes, for example, a blue LED and the light conversion element includes, for example, a red phosphor material and a green phosphor material. In the embodiment of FIG. 5C, a spectrum LC is generated under a structure in which the light emitting unit includes, for example, a blue LED and the light conversion element includes, for example, a yellow phosphor material and a red phosphor material. In the embodiment of FIG. 5D, a spectrum LD is generated under a structure in which the light emitting unit includes, for example, a blue LED and the light conversion element includes, for example, a second type quantum dot. In the embodiment of FIG. 5E, a spectrum LE is generated under a structure in which the light emitting unit includes, for example, a blue LED and the light conversion element includes, for example, a third type quantum dot, wherein a full width at half maximum range of each main wave is greater than or equal to 15 nm.

Please refer to FIG. 5A to FIG. 5E. The spectrum (for example, any one of the spectrum LA to the spectrum LE) measured when the panel 111 of the electronic device 1A displays the white screen may have the first main wave λ1, the first peak P1 of the first main wave λ1 is, for example, greater than or equal to 580 nm and less than or equal to 680 nm, and the first main wave λ1 has a first full width at half maximum range of greater than or equal to 15 nm. When the first full width at half maximum of the first peak P1 is too narrow, the display beam of the electronic device 1A may easily generate interference, which easily generates a rainbow pattern. Therefore, by changing the magnitude of the full width at half maximum (for example, the first full width at half maximum) of at least one main wave (for example, the first main wave) in the spectrum measured when the panel 111 displays the white screen, the rainbow pattern may be alleviated. While using the super retardation film 120 to increase the shielding of the display beam by the linearly polarized sunglasses, the quality of the display screen may also be further improved, thereby enhancing the viewing experience of the user. It should be noted that the first full width at half maximum (FWHM) here refers to the wavelength range corresponding to half of a peak value (for example, about 0.020 in FIG. 5A) of a relative intensity of the first peak P1 in the first main wave λ1. In FIG. 5A, the first full width at half maximum is about 30 nm to 40 nm (that is, 30 nm ≦ first full width at half maximum ≦ 40 nm). In FIG. 5B, the first full width at half maximum is about 95 nm to 105 nm (that is, 95 nm ≦ first full width at half maximum ≦ 105 nm). In FIG. 5C, the first full width at half maximum is about 55 nm to 65 nm (that is, 55 nm ≦ first full width at half maximum ≦ 55 nm). In FIG. 5D, the first full width at half maximum is about 15 nm to 25 nm. In FIG. 5E, the first full width at half maximum is about 15 nm to 25 nm (that is, 15 nm ≦ first full width at half maximum ≦ 25 nm). Definitions of the full width at half maximum (the first full width at half maximum) of the main waves in FIG. 5A to FIG. 5E are all the same and will not be described again.

Further, the spectrum (for example, any one of the spectrum LA to the spectrum LE) measured when the panel 111 displays the white screen may also have a second main wave λ2, a second peak P2 of the second main wave λ2 is greater than or equal to 480 nm and less than or equal to 579 nm, and the second main wave λ2 has a second full width at half maximum range of greater than or equal to 20 nm. In FIG. 5A, the second full width at half maximum is about 35 nm to 45 nm (that is, 35 nm ≦ second full width at half maximum ≦ 45 nm). In FIG. 5B, the second full width at half maximum is about 45 nm to 55 nm (that is, 45 nm ≦ second full width at half maximum ≦ 55 nm). In FIG. 5C, the second full width at half maximum is about 60 nm to 70 nm (that is, 60 nm ≦ second full width at half maximum ≦ 70 nm). In FIG. 5D, the second full width at half maximum is about 25 nm to 35 nm. In FIG. 5E, the second full width at half maximum is about 25 nm to 35 nm (that is, 25 nm ≦ second full width at half maximum ≦ 35 nm).

Similar to the above, the second main wave λ2 having the second full width at half maximum range of greater than or equal to 20 nm may also alleviate the rainbow pattern. Another point to mention is that if the respective full width at half maximums of the first main wave λ1 and the second main wave λ2 are too large, color saturation of color lights in the display beam is reduced, affecting the color purity of the display screen. Therefore, the selection of the first full width at half maximum range of the first main wave λ1 and the second full width at half maximum range of the second main wave λ2 may comply with more than 70% of a color space defined by the National Television System Committee (NTSC). Under the above condition, the electronic device 1A of the disclosure may have a lower cost, making the product pricing more competitive. For example, the second full width at half maximum range may be less than 70 nm, but not limited thereto. For example, the first full width at half maximum range may be less than 70 nm, but not limited thereto.

In some embodiments, the spectrum (for example, any one of the spectrum LA to the spectrum LE) measured when the panel 111 displays the white screen may also have a third main wave λ3, and a third peak P3 of the third main wave λ3 is greater than or equal to 380 nm and less than or equal to 479 nm. In some embodiments, an intensity of the first peak P1 and an intensity of the second peak P2 may be less than or equal to 0.7 times an intensity of the third peak P3, but not limited thereto. In some embodiments, the intensity of the first peak P1 and the intensity of the second peak P2 may be less than or equal to 0.65 times (or 0.6 times, or 0.55 times, or 0.5 times) the intensity of the third peak P3. By reducing the intensity of the first peak P1 (such as reducing an intensity of a red light spectrum in the color light) and the intensity of the second peak P2 (such as reducing an intensity of a green light spectrum in the color light) as a proportion of the overall light emission, the rainbow pattern of the display screen may be alleviated, improving the quality of the display screen.

Please refer to FIG. 6. FIG. 6 is a spectrum comparison diagram of a normalized intensity of the backlight module 100 of the electronic device according to different embodiments. It can be seen from the drawing that the backlight module 100 adopts quantum dots as a light conversion material (as shown in the spectrum LA, the spectrum LD, and the spectrum LE), which, for example, has better light conversion efficiency and higher color purity to alleviate the rainbow pattern. On the other hand, the backlight module 100 may also adopt a fluorescence material as a light conversion element (as shown in the spectrum LB and the spectrum LC), which may also alleviate the rainbow pattern in addition to mature technology and cost reduction. Furthermore, under a structure in which the light emitting element adopts a blue LED, the blue LED may adopt a chip on board (COB) structure to save cost or meet thinning requirements.

Please continue to refer to FIG. 1. In some embodiments, the super retardation film 120 may be disposed on the upper polarizing plate 112 via the adhesion layer 130. In other words, in the thickness direction of the electronic device 1A, two opposite sides of the adhesion layer 130 may respectively contact the super retardation film 120 and the upper polarizing plate 112, but not limited thereto. The material of the adhesion layer 130 includes, for example, an optical clear adhesive (OCA), an optical pressure sensitive adhesive (PSA), a silicone adhesive, a polyurethane reactive (PUR) adhesive, a polyurethane (PU) adhesive, or other suitable optical adhesives. The adhesion layer 130 may be made of an optical adhesive with higher transmittance (for example, the optical clear adhesive). For example, the transmittance of the adhesion layer 130 may be greater than or equal to 85% (or 90%), but not limited thereto. In the embodiment, the super retardation film 120 and the adhesion layer 130 are, for example, both disposed on the upper polarizing plate 112, thus serving as protective film layers of the upper polarizing plate 112, improving the reliability of the electronic device 1A.

Please refer to FIG. 2. An electronic device 1B is similar to the electronic device 1A shown in FIG. 1, and the main difference is explained below. The electronic device 1B in FIG. 2 may also include a cover plate 140 disposed on the super retardation film 120. Specifically, the adhesion layer 130 may respectively adhere to the cover plate 140 and/or the super retardation film 120. The cover plate 140 includes, for example, a glass cover plate, a plastic cover plate, or other suitable cover plates, but the disclosure is not limited thereto. The cover plate 140 may enhance the device reliability of the electronic device 1B and protect the upper polarizing plate 112. In other embodiments (not shown), the super retardation film 120 may also be disposed on the cover plate 140, that is, the cover plate 140 may be disposed between the super retardation film 120 and the upper polarizing plate 112. The super retardation film 120 is, for example, closer to the display surface than the upper polarizing plate 112 of the panel 110.

Please refer to FIG. 3. An electronic device 1C is similar to the electronic device 1A shown in FIG. 1, and the main difference is explained below. In the electronic device 1C in FIG. 3, a panel 110A of a self-luminous display serves as a display light source. The electronic device 1C may include the panel 110A, the upper polarizing plate 112, the adhesion layer 130, and the super retardation film 120 sequentially arranged along the thickness direction of the electronic device 1C, and the electronic device 1C may not include the backlight module 100 and the lower polarizing plate 113 in FIG. 1, but not limited thereto. In the electronic device 1C, other layers or elements may be inserted or any of the above layers or elements may be deleted according to requirements. The panel 110A includes, for example, an organic light emitting diode (OLED) display panel, a mini LED display panel, or a micro LED display panel, but not limited thereto. The self-luminous display often adopts a reflective electrode as the electrode on the side away from the display surface to increase the light emitting brightness of the display beam, which causes stray light (or glare) to be easily generated when ambient light is irradiated onto the display panel, reducing the contrast of the display screen. Therefore, providing the upper polarizing plate 112 on the light emitting side of the panel 110A (that is, the side of the panel 110A facing the super retardation film 120) may reduce the proportion of ambient light reflection, reducing the stray light, but not limited thereto.

Through adopting the super retardation film 120 to increase the shielding of the display beam by the linearly polarized sunglasses, the user may view the display screen regardless of whether the electronic device 1C is rotated at any angle relative to the user or the tilt angle of the electronic device 1C is changed. In addition, through the design of the first full width at half maximum range being greater than or equal to 15 nm (for example, refer to the spectrum in FIG. 5A to FIG. 5E), the electronic device 1C may effectively alleviate the rainbow pattern. Reference may be made to the foregoing paragraphs for relevant content, which will not be repeated here.

Please refer to FIG. 4. An electronic device 1D is similar to the electronic device 1C shown in FIG. 3, and the main difference is explained below. The electronic device 1D in FIG. 4 may also include a cover plate 140 disposed on the super retardation film 120. Specifically, the adhesion layer 130 may respectively adhere to the cover plate 140 and the super retardation film 120. Therefore, the electronic device 1D may also have similar technical effects as the electronic device 1C and the electronic device 1B.

Please refer to FIG. 7. Any one of the electronic device 1A to the electronic device 1D is configured to be installed on a transportation device 10. That is, the electronic device 1A to the electronic device 1D may include a panel (for example, the panel 111 or the panel 110A) and the super retardation film 120 disposed on the panel. For convenience of explanation, only the display module 110 and the super retardation film 120 in the electronic device (the electronic device 1A to the electronic device 1D) are schematically shown in the drawing, and the illustrations and the labels of the remaining elements are omitted. On the other hand, the electronic device (the electronic device 1A to the electronic device 1D) may also include a control module 200 for rotating the display module 110 (such as rotating the panel 111 in the display module 110) or adjusting the tilt angle of the display module 110 (such as adjusting the tilt angle of the panel 111). The control module 200 may, for example, include a robotic arm or any rotatable mechanical structure and a control element controlling the mechanical structure. For example, the control module 200 may be a supporting structure, etc. that may be manually or electrically controlled by the user, so that the display surface of the panel 111 of the display module 110 of the electronic device may rotate (dotted lines of different thicknesses are used to represent different rotation angles and placement positions of the display module 110 and the super retardation film 120 in FIG. 7), but not limited thereto. The control module 200 may be, for example, located next to a steering wheel 2 of a front seat and disposed on a dashboard 3 or disposed behind the front seat for a rear seat passenger (not shown) to view in conjunction with any one of the electronic device 1A to the electronic device 1D, but not limited thereto. The transportation device 10 illustrated in FIG. 7 is, for example, a car, but not limited thereto. The transportation device 10 may include a bus, a ship, an airplane, a freighter, a motorcycle, or other suitable transportation devices.

Similar to the above, in the transportation device 10, through adopting the super retardation film 120 to increase the shielding of the display beam by the linearly polarized sunglasses, the user may view the display screen regardless of whether the display module 110 (the panel 111) is rotated at any angle relative to the user or the tilt angle of the display module 110 (the panel 111) is changed. In addition, through the design of the first full width at half maximum range being greater than or equal to 15 nm (for example, refer to the spectrum in FIG. 5A to FIG. 5E), the rainbow pattern may be effectively alleviated. While the product has a lower cost, the versatility of the display in the transportation device is greatly improved and the rainbow pattern is alleviated, effectively improving product competitiveness.

The above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

Although the embodiments and the advantages of the disclosure have been disclosed above, it should be understood that any person skilled in the art may make changes, substitutions, and modifications without departing from the spirit and scope of the disclosure, and the features of the embodiments may be arbitrarily mixed and replaced to form other new embodiments. In addition, the protection scope of the disclosure is not limited to processes, machines, manufactures, material compositions, devices, methods, and steps in the specific embodiments described in the specification. Any person skilled in the art may understand conventional or future-developed processes, machines, manufactures, material compositions, devices, methods, and steps from the content of the disclosure as long as the same may implement substantially the same functions or obtain substantially the same results as the embodiments described herein when used according to the disclosure. Therefore, the protection scope of the disclosure includes the above processes, machines, manufactures, material compositions, devices, methods, and steps. In addition, each claim constitutes an individual embodiment, and the protection scope of the disclosure further includes combinations of the claims and the embodiments. The protection scope of the disclosure should be defined by the appended claims.

WHAT IS CLAIMED IS:

1. An electronic device, comprising:
a panel;
a super retardation film, disposed on the panel;
wherein when the panel displays a white screen, a spectrum is measured on a light emitting surface of the panel, the spectrum has a first main wave, a first peak of the first main wave is greater than or equal to 580 nm and less than or equal to 680 nm, the first main wave has a first full width at half maximum range, and the first full width at half maximum range is greater than or equal to 15 nm.

2. The electronic device according to claim 1, wherein the spectrum also has a second main wave, a second peak of the second main wave is greater than or equal to 480 nm and less than or equal to 579 nm, the second main wave has a second full width at half maximum range, and the second full width at half maximum range is greater than or equal to 20 nm.

3. The electronic device according to claim 1, wherein the spectrum also has a second main wave and a third main wave, a second peak of the second main wave is greater than or equal to 480 nm and less than or equal to 579 nm, and a third peak of the third main wave is greater than or equal to 380 nm and less than or equal to 479 nm, wherein an intensity of the first peak and an intensity of the second peak are less than or equal to 0.7 times an intensity of the third peak.

4. The electronic device according to claim 1, wherein an in-plane phase difference value of the super retardation film is greater than or equal to 3000 nm and less than or equal to 30000 nm.

5. The electronic device according to claim 1, further comprising:
an upper polarizing plate, disposed between the super retardation film and the panel, wherein an included angle between an absorption axis of the upper polarizing plate and a slow axis of the super retardation film is greater than or equal to 30 degrees and less than or equal to 60 degrees.

6. The electronic device according to claim 1, further comprising:
a backlight module, disposed under the panel, the backlight module comprising:
a light emitting unit; and
a light conversion element, disposed on the light emitting unit, wherein the light conversion element comprises a quantum dot, a fluorescence material, or a phosphor material.

7. The electronic device according to claim 5, further comprising an adhesion layer, wherein two opposite sides of the adhesion layer respectively contact the super retardation film and the upper polarizing plate.

8. The electronic device according to claim 1, wherein the panel is a self-luminous display.

9. The electronic device according to claim 1, further comprising a cover plate and an adhesion layer, wherein the adhesion layer is disposed between the cover plate and the super retardation film.

10. The electronic device according to claim 9, wherein a material of the cover plate comprises glass or plastic.

11. An electronic device, configured to be installed on a transportation device, the electronic device comprising:
a panel;
a super retardation film, disposed on the panel; and
a control module, configured to rotate the panel or adjust a tilt angle of the panel.

12. The electronic device according to claim 11, wherein when the panel displays a white screen, a spectrum is measured on a light emitting surface of the panel, the spectrum has a first main wave, a first peak of the first main wave is greater than or equal to 580 nm and less than or equal to 680 nm, the first main wave has a first full width at half maximum range, and the first full width at half maximum range is greater than or equal to 15 nm.

13. The electronic device according to claim 12, wherein the spectrum also has a second main wave, a second peak of the second main wave is greater than or equal to 480 nm and less than or equal to 579 nm, the second main wave has a second full width at half maximum range, and the second full width at half maximum range is greater than or equal to 20 nm.

14. The electronic device according to claim 12, wherein the spectrum also has a second main wave and a third main wave, a second peak of the second main wave is greater than or equal to 480 nm and less than or equal to 579 nm, and a third peak of the third main wave is greater than or equal to 380 nm and less than or equal to 479 nm, wherein an intensity of the first peak and an intensity of the second peak are less than or equal to 0.7 times an intensity of the third peak.

15. The electronic device according to claim 11, wherein an in-plane phase difference value of the super retardation film is greater than or equal to 3000 nm and less than or equal to 30000 nm.

16. The electronic device according to claim 11, further comprising:
an upper polarizing plate, disposed between the super retardation film and the panel, wherein an included angle between an absorption axis of the upper polarizing plate and a slow axis of the super retardation film is greater than or equal to 30 degrees and less than or equal to 60 degrees.

17. The electronic device according to claim 16, further comprising an adhesion layer, wherein two opposite sides of the adhesion layer respectively contact the super retardation film and the upper polarizing plate.

18. The electronic device according to claim 11, wherein the panel is a self-luminous display.

19. The electronic device according to claim 11, further comprising a cover plate and an adhesion layer, wherein the adhesion layer is disposed between the cover plate and the super retardation film.

20. The electronic device according to claim 19, wherein a material of the cover plate comprises glass or plastic.
